(19) United States
(12) Patent Application Publication
(10) Pub. No.: US 2026/0188095 A1
(43) Pub. Date: Jul. 2, 2026

(54) CONTEXT-AWARE AUTONOMOUS CONTROL AND UTILIZATION OF PTZ CAMERAS TO PROACTIVELY TRACK AND MONITOR FOR SAFETY VIOLATIONS AND INCIDENTS IN LARGE CONSTRUCTION SITES

(71) Applicant: Saudi Arabian Oil Company, Dhahran (SA)

(72) Inventors: Bashar Altakrouri, Dhahran (SA); Hasan Badawy, Dhahran (SA)

(21) Appl. No.: 19/008,165

(22) Filed: Jan. 2, 2025

(51) Int. Cl. G08B 21/02; G06V 10/70; G06V 20/52; G08B 31/00; H04N 23/695

(52) U.S. Cl. CPC G08B 21/02; G06V 10/70; G06V 20/52; G08B 31/00; H04N 23/695

(57) ABSTRACT

A computer-implemented method for potential hazard identification, includes receiving, from one or more cameras, image data of a scene, identifying, based on the image data and as identified activities, one or more activities occurring at the scene, based on the identified activities, detecting a safety-relevant entity activity and zone at the scene, determining whether additional image data is required to detect whether a hazard occurred based on the detected safety-relevant entity activity and zone at the scene, accordingly adjust the camera control system autonomously, if additional image data is not required, then analyzing the image data to detect whether a hazard occurred, detecting that a hazard occurred, and communicating to a user device, a notification indicating that the hazard occurred and providing a mitigation action, where the additional image data is focused high-spatial resolution image data.

### BACKGROUND

The presence of hazards (e.g., vehicles, heavy machinery, electrical equipment, chemicals, and elevated work areas) at large construction sites place persons at these sites at high-risk for potential accidents from falls, electrocution, exposure injuries, struck-by accidents, etc. or damage to expensive machinery. The implementation of safety enforcement measures can significantly reduce the risks of accidents occurring and help to create a safer environment for everyone.

### SUMMARY

The present disclosure describes context-aware autonomous control and utilization of Pan-Tilt-Zoom (PTZ) cameras to proactively and dynamically, track and monitor, large construction sites for safety violations and incidents.

In an implementation, a computer-implemented method for potential hazard identification comprises: receiving, from one or more cameras, image data of a scene; identifying, based on the image data and as identified activities, one or more activities occurring at the scene; based on the identified activities, detecting a safety-relevant entity activity and zone at the scene; determining whether additional image data, that is, focused high spatial-resolution image data (i.e., high spatial resolution image data with focused field of view) is required to detect whether a hazard occurred based on the detected safety-relevant entity activity and zone at the scene, accordingly the camera control system will be autonomously adjusted; if focused high spatial-resolution image data is not required, then: analyzing the image data to detect whether a hazard occurred; detecting that a hazard occurred; and communicating to a user device, a notification indicating that the hazard occurred and providing a mitigation action.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages.

First, utilizing one or more context-aware autonomous cameras to monitor a site is advantageous over traditional manual monitoring because large areas can be continuously monitored without the concern of overlooking a potential incident caused by human error.

Second, the described system increases the efficiency of processing large sets of various types of data by utilizing several different image processing techniques and machine learning (ML) models simultaneously on the large data sets.

Third, the described system is configured to make real-time determinations which leverages the large data sets and contextual event data to provide accurate determinations.

Fourth, the described system is configured to make real-time determinations which leverages the large data sets and contextual event data to control PTZ camera system autonomously.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIGS. 1A and 1B are examples of monitoring a construction site for hazards, according to an implementation of the present disclosure.

FIG. 2A is a partial flowchart illustrating a process for context-aware risk monitoring based on Pan-Tilt-Zoom (PTZ) cameras, according to an implementation of the present disclosure.

FIG. 2B is a continuation of the partial flowchart from FIG. 2A of a process for context-aware risk monitoring based on PTZ cameras, according to an implementation of the present disclosure.

FIG. 3A is a partial block diagram of a system architecture of adaptive context-aware risk video monitoring system, according to an implementation of the present disclosure.

FIG. 3B is a continuation of the partial block diagram from FIG. 3A of a system architecture of adaptive context-aware risk video monitoring system, according to an implementation of the present disclosure.

FIG. 4 is a flow chart illustrating a process for communicating a notification indicating that a hazard occurred and providing a mitigation action, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

FIG. 6 illustrates hydrocarbon production operations that include both one or more field operations and one or more computational operations, which exchange information and control exploration for the production of hydrocarbons, according to an implementation of the present disclosure.

Like reference numbers and designations in the various drawings indicate like elements.

### DETAILED DESCRIPTION

The following detailed description describes context-aware autonomous control and utilization of Pan-Tilt-Zoom (PTZ) cameras to proactively and dynamically, track and monitor, large construction sites for safety violations and incidents, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

The risk of injury to persons or the damage to expensive machinery are some of the potential hazards that occur at construction sites or large work sites. Continuous monitoring of the construction sites for the occurrence of potential hazards is necessary to help reduce the risk of such occurrences. The system described herein continuously, proactively, and dynamically tracks and monitors safety violations and incidents of workers at large construction sites, using context-aware autonomous control of PTZ cameras. The system can determine whether focused high spatial-resolution image data of a scene is required to determine if a hazard occurred at the site. The system leverages large data sets of historical data to develop and train one or more machine learning (ML) modules to identify people, objects, or events at the construction site. The historical data includes several different types of data associated with the construction site, and the data is essential to provide detailed context of the events at the site.

In some implementations, the system is supported by a server that is in communication with the plurality of cameras at the site, and that is configured to store and analyze the historical data. The server can include one or more databases or distributed file systems to efficiently store the large data sets. The server optimizes data analysis by using a combination of query languages, analytics tools, ML frameworks, and other data processing techniques. When the plurality of cameras captures image data from the construction site, the image data is communicated to the server, in real-time, and the server can provide real-time determinations of the events occurring at the site based on analysis of the large data sets of “contextual event data” and image data.

In some implementations, the system can autonomously adjust parameters of cameras at the site to capture image data of a specific area or person, or to capture focused high spatial-resolution images to improve the confidence or reliability of the determinations made by the system. The system can further provide notification of a detected hazard events and can provide mitigation measures to mitigate a detected risk. Autonomously adjusting cameras to capture just in time and right image data not only helps to improve the confidence of the determinations made by the system but helps with the optimization of resources by reducing the compute power required by the system when high resolution images are not required for determinations.

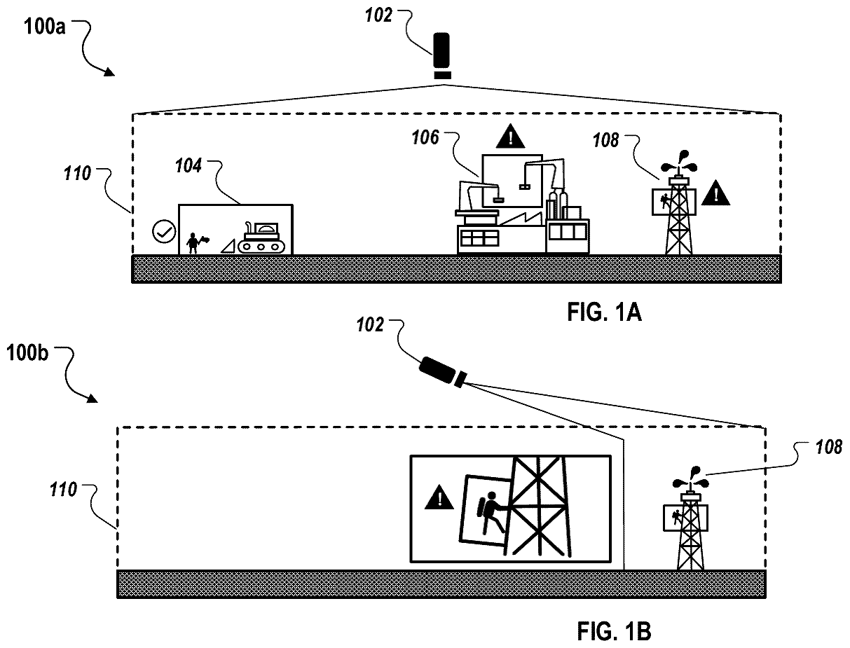

FIGS. 1A and 1B are examples 100a and 100b, respectively, of monitoring a construction site for hazards, according to an implementation of the present disclosure.

As illustrated in example 100a of FIG. 1A, a camera 102 may be configured to capture images of a construction site 110. The camera 102 may be a PTZ camera that is capable of capturing panoramic images of the one or more work zones 104, 106, 108 within a construction site 110. The PTZ camera 102 may be used for surveillance of a construction site 110, and has the ability to move horizontally, vertically, and to zoom in or out. In some implementations, one or more cameras 102 may be located throughout the construction site 110.

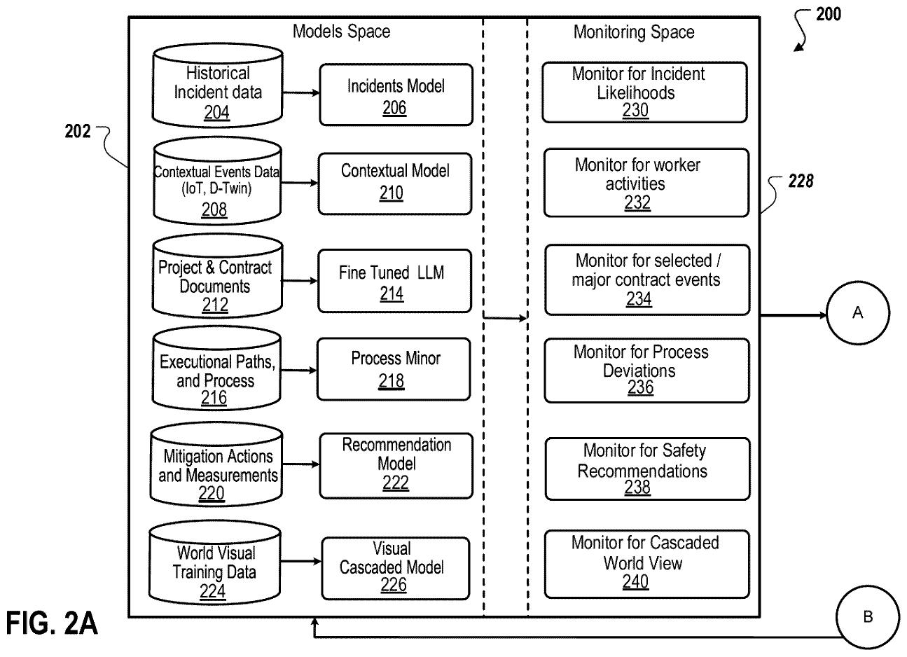

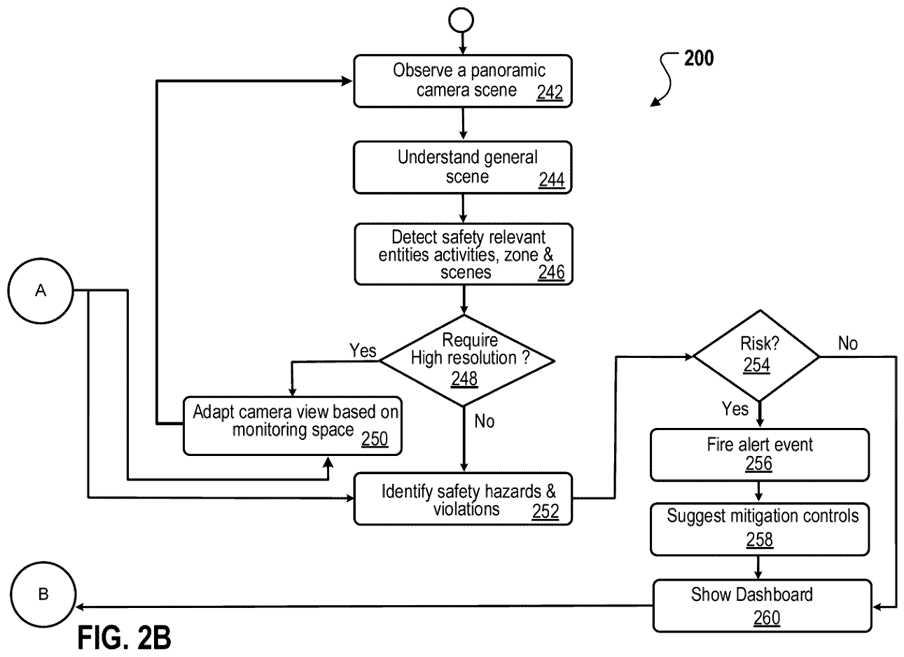

The camera 102 may be in electronic communication with a server (not shown) which includes processing electronics, and that supports the tracking and monitoring of safety violations and incidents at the construction site 110. During an initial data gathering and preprocessing stage(s), the server may also receive one or more additional types of historical and contextual event data associated with the construction site 110. For example, as described with more detail with respect to FIGS. 2A and 2B, the server can, in some implementations, receive historical incident data, contextual event data, project and contract data, executional path and process data, mitigation action and measurements data, and world visual training data.

At a high-level, the camera 102 captures image data of the construction site 110 and communicates the captured image data to the server. The server analyzes the received image data and utilizes one or more ML modules trained during the preprocessing stages to analyze the received image data and any associated contextual event data. Based on the data analysis, the server determines that there is no potential hazard occurring in work zone 104. The data analysis and processing steps performed by the server are described in more detail with reference to FIGS. 2A and 2B. In example 100a, the server determines that additional focused high spatial-resolution image data of the work zone 104 is not required based on determining that there is no potential hazard occurring in work zone 104.

However, based on the analysis of the data, the server determines that there is a potential hazard occurring in work zone 106. As illustrated in FIG. 1A, the work zone 106 includes two cranes proximate to each other. When the server receives the images captured of the construction site 110, the server may utilize one or more object identification techniques to identify the first crane and the second crane and to determine a distance between the first and second cranes.

In example 100a for work zone 106, the server determines that work zone 106 is a potential hazard based on the server determining that first crane and the second crane are less than a threshold distance apart from each other based on processing and analyzing the image data. The server further determines, based on the analyzing the contextual event data associated with the construction site 110 that parallel operation of the cranes is part of an approved project. For example, when the server analyzes the data, an output of a fine-tuned large language model (LLM) trained in project and contract data confirms that the operation of the two cranes simultaneously is an approved project/condition. Based at least on the determination and confirmation, the server determines that additional focused high spatial-resolution image data of work zone 106 is not required.

With respect to work zone 108 and based on the analysis of the associated data, the server determines that there is a potential hazard occurring in work zone 108. As illustrated in FIG. 1A, work zone 108 illustrates a person on an oil rig. When the server receives the image data captured of the construction site 110, the server may utilize one or more different data analysis techniques to process the image data and the contextual event data associated with the construction site 110. In the example, the server determines that the work zone 108 is a potential hazard based on the server determining that the person on the oil rig is more than a threshold distance above the ground. The server further determines, based on the analyzing the contextual event data associated with the construction site 110 that the worker being on the oil rig at the current time is not part of an approved project or condition. For example, when the server analyzes the data, an output of a fine-tuned LLM trained in project and contract data confirms that the worker on the oil rig is not a part of an approved project.

Here, the server determines that focused high spatial-resolution images (e.g., zoomed-in images) of work zone 108 are required. In some implementations, the server determines that focused high spatial-resolution image data is required of a work zone of a construction site where one or more potential hazards are detected. For example, the server may determine that focused high spatial-resolution image data is required when the server determine that (1) a worker is working without the required approval, (2) the server determines that a hazard to the work is present, and (3) the server determines that there is not sufficient resolution to determine whether mitigation measures are present. In other implementations, the server determines that focused high spatial-resolution image data of a work zone is required when a confidence or probability of a prediction of whether or not a hazard occurred is below a threshold value. In some implementations, the server may determine that focused high spatial-resolution image data of the scene is required when a potential hazard occurs in a peripheral area or at an edge of frame of at least the one or more captured images of the image data. In some implementations, the server determines that image data with a better field of view is required. For example, the server may determine that a better field of view of a work zone at the construction site is required.

When a determination is made that focused high spatial-resolution image data is required, the server commands the camera 102 to adjust its parameters to capture the focused high spatial-resolution images of work zone 108. As illustrated in FIG. 1B, the camera 102 is panned and or tilted until work zone 108 is at the center of the field of view of the camera 102 before capturing one or more focused high spatial-resolution images of work zone 108. The camera 102 may zoom in to capture the one or more focused high spatial-resolution images of work zone 108. The one or more focused high spatial-resolution images of work zone 108 is communicated to the server, and the server analyzes the additional image data to determine with greater accuracy and confidence, that a hazard occurred at work zone 108. In some implementations, when the server determines that image data with a better field of view is required, the server commands the camera 102 to adjusts its field of view to capture additional images of the work zone 108,

In some implementations, the server may communicate a notification to a graphical user interface (GUI) (e.g., a “dashboard”-type interface) at the construction site 110 indicating that a hazard occurred. In some implementations, the notification includes details of the hazard detected. In some implementations, the notification includes an image of the detected hazard. The notification may also include details of suggested mitigation steps to remedy the hazard. In some implementations, when the detected hazard is a fire, the server may communicate with one or more speakers at the construction site 110 to output an audible alarm. In some implementations, the server may communicate with one or more speakers at the construction site 110 to transmit contextual messages to workers regarding a detected hazard, mitigation steps, or other information associated with the detected hazard. In some implementations, the server may communicate with a sensor or other device at the construction site 110 to perform an action based on detecting that a hazard has occurred. For example, the server may communicate with a door lock to automatically lock based on detecting a potential hazard in a room at the construction site 110. In another example, the server may communicate with a large piece of equipment to instruct the equipment to shut off based on detecting that a hazard has occurred. For example, the server may communicate with a reactor to shut down based on determining that the temperature of the reactor has exceeded a threshold temperature.

In some implementations, the server is configured to receive feedback from a safety operator that manages the construction site 110. The safety operator may oversee the construction site 110, and review areas where a potential hazard was detected. The safety operator may confirm or deny the predictions of whether a hazard actually occurred. In some implementations, the safety operator may provide feedback to the server to indicate the strength of the predictions performed by the server. The safety operator may provide a score to indicate the accuracy of the prediction made by the server.

In some implementations, the server may implement a closed loop system to evaluate the accuracy of the predictions made. In these implementations, the server may receive data from one or more attention sensors for the operators of a machine that has a proactive safety enforcement actuator, such as, a vibrating steering wheel. When the server identifies a potential hazard, and a notification is sent to the operator of the machine, the attention sensors may be configured to register higher levels of attention from the operator. Based on the system notifying the operator of the machinery to pay closer attention, the system may now focus on other areas of the construction site where there is no explicit human interaction or input. For example, the server may communicate with the one or more cameras 102 to capture image data from the one or more other zones of the construction site. In this example, a positive behavior was recorded after a mitigation action. This leads to a smarter system as the system is now more confident on which actions lead to safer work at the site.

FIG. 2A is a partial flowchart illustrating a process for context-aware risk monitoring based on PTZ cameras, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

### Data Gathering and Pre-Processing (Models Space)

The server that supports the functionality of the described approach can include one or more databases or distributed file systems to efficiently store large data sets. As illustrated in FIG. 2A, the server may be segmented into a models space and a monitoring space.

The models space 202 of the server receives various forms of data (e.g., as previously described or other data), and stores, processes, and analyzes the received data.

At 204, the server receives and stores historical incident data. The historical incident data may be received from one or more servers at one or more monitored construction sites and or large industrial work sites. In some implementations, the historical incident data may be received from one or more different databases which receive and store incident data. For example, the historical data may be received from a single organization, or in other examples, the historical data may be received from a plurality of organizations. For example, the incident data may be received in the form of a published report, or from an international governing organization. In some implementations, the historical incident data may be received continuously from the one or more servers at the one or more monitored construction sites or large industrial work sites. In some implementations, the historical incident data may be received periodically. For example, the historical incident data may be received from one or more construction sites every day, every month, every year, or any other suitable period. The historical incident data may be stored in an isolated data storage unit at the server or geographically remote from the server. The historical incident data storage unit at the server may be in communication with one or more other data storage units.

In some implementations, the server may receive and store data from one or more third party services. The data received from the one or more third party services may be real time data, or near real time data. For example, the server may receive and store satellite footage of the monitored construction site 110. For example, the server may receive and store traffic data for the areas around the construction site 110. In some implementations, the server may receive live weather data and historical weather data for the geographical area where the construction site 110 is located.

At 206, the server may preprocess the stored historical incident data to identify any inconsistencies or outliers within the stored data. The server analyzes the historical incident data to identify which features within the data will be used to train an incidents model. For example, the server may analyze the historical incident data to determine the relevance and the importance of the different features within the data stored at the server. The server uses the data and one or more ML algorithms to train an incidents model to learn the patterns and the relationships within the historical incident data. In some implementations, the server may train the incidents model to identify minor safety incidents, major safety incidents, safety observations, and any other appropriate pattern in the historical incident data. In some implementations, the incidents model maintains a bank of a plurality of incidents to monitor a construction site 110 for.

At 208, the server receives and stores contextual event data (Internet of Things (IoT), Digital Twin (D-Twin)). The contextual event data may be received from one or more servers at the construction site 110. The one or more physical devices at the construction site 110 may be embedded with sensors, software, and other technologies which allow the physical devices to connect and exchange data with other devices and systems over the internet. The one or more sensors of the one or more physical devices collect data about the surrounding environment at the construction site 110 and the data is received and stored in a contextual event data storage unit. The contextual event data storage unit at the server may be in communication with one or more other data storage units.

At 210, the server may preprocess the stored contextual event data to identify any inconsistencies or outliers within the stored data. The server analyzes the contextual event data to identify which features within the data will be used to train a contextual model. The server uses the data and one or more ML algorithms to train a contextual model to learn the patterns and the relationships within the contextual model data. In some implementations, the server may aggregate the data to generate a contextual model that resembles a digital twin of the construction site 110 that covers people, objects, and physical spaces.

At 212, the server receives and stores project and contract documents. The project and contract data may be received from one or more servers at the monitored construction site 110. The project and contract data may be received continuously from the one or more servers at the monitored construction site 110. In some implementations, the project and contract data may be received periodically. For example, the project and contract data may be received from the monitored construction site every day, every month, every year, or any other suitable period. The project and contract data may be stored in an isolated data storage unit at the server. The project and contract data storage unit at the server may be in communication with one or more other data storage units.

At 214, the server may preprocess the stored project and contract data. The server analyzes the project and contract data to identify which features within the data will be used to train a finely tuned LLM. The server uses the project and contract data and one or more ML algorithms to train the fine-tuned LLM to learn the patterns and the relationships within the project and contract data. The fine-tuned LLM may be trained to identify, recognize and generate particular words, phrases, or text within the project and contract data.

At 216, the server receives and stores executional paths and process data. The executional paths and process data may be received from one or more servers at the monitored construction site 110. The executional paths and process data may be received continuously from the one or more servers at the monitored construction site 110. The executional paths and process data may be stored in an isolated data storage unit at the server. The executional paths and process data storage unit at the server may be in communication with one or more other data storage units.

At 218, the server may preprocess the stored executional paths and process data. The server analyzes the executional paths and process data to generate a process minor ML language model that resembles the one or more executional paths and processes within a given project.

At 220, the server receives and stores potential mitigation actions and measurements data. The potential mitigation actions and measurements data may be received from one or more servers at one or more monitored construction sites and or large industrial work sites. The potential mitigation actions and measurements data may be received in conjunction with the historic incident data. For example, for each identified incident in the historic incident data may also include details about the mitigation steps taken in response to the identified incident. The potential mitigation actions and measurements data may be stored in an isolated data storage unit at the server. The potential mitigation actions and measurements storage unit at the server may be in communication with one or more other data storage units.

At 222, the server may utilize the stored potential mitigation actions and measurements data and the historical incident data to train recommendation ML model. The server analyzes the potential mitigation actions and measurements data and the historical incident to identify which features within the data will be used to train the model.

At 224, the server receives and stores world visual training data. The visual data may be received available public datasets (open source or commercial), various sources of stored visual data from the organization outside the current construction site, or from stored visual data from captured from the current construction site.

At 226, the server may utilize the stored world visual training data to train a visual cascaded ML model. The server analyzes the world visual training data to identify which features within the data will be used to train the model.

The server may utilize different types of visual datasets, and may process and use the different types of visual datasets differently. In some implementations, general datasets may be used for building generalized models to detect objects, such as detecting people, buildings, types of vehicles, etc.). In some implementations, other datasets may be used to detect scenarios, such as a walking person, a moving vehicle, etc.). In other implementations, other more complex and specialized datasets may be used for training more complex models that are configured to for detect safe and violation scenarios. Each of the one or more resulting models from the different datasets are configured to contribute to training the cascaded ML model. The cascaded ML model may be configured to perceive the world from various perspectives, that is, simple objects and entities, to more complex scenes.

### Processing Data (Monitoring Space)

At 228, the server uses the one or more ML models generated in the models space at 202 to monitor for specific events. The server may use the one or more ML models generated in the models space at 202 to monitor for different types of events, activities, and situations that help to form a holistic (i.e., general) understanding of a particular scene or recognition of a specific event.

At 230, the server utilizes the generated incidents ML model to monitor for incident likelihood data received. Incidents likelihood data may include safety incidents, major safety incidents, and safety observations. The monitoring incidents likelihood is a continuous process to generate, store, utilize, and/or monitor a bank of potential incidents and targets for the system to monitor for. The ML models generated in the models space may be configured to suggest potential incidents identified from previous data records and incident events, or may synthetically create potential incidents to monitor for.

At 232, the server utilizes the generated contextual ML model to monitor for workers activities. The worker activities data may include any contextual traces to any state or action of one or more workers in the construction site 110. The monitoring may involve collecting, storing and analyzing live and near live data on workers, objects, and zones at the construction site 110. In some implementations, the worker activities data may be collected directly form sensors mounted on one or more workers at the construction site 110, or from the physical space. The worker activities data may be collected from readily available source of context data, such as, a digital twin of the worker, equipment, physical zone or the whole construction site.

At 234, the server utilizes the generated finely tuned large learning model to monitor for selected major contracted events. Contract events data may include any traces related to the different stages and milestones of the project at the construction site 110. In some implementations, the monitoring may involve collecting, storing, and analyzing data on the work progress, delivery timeline and schedules, planned and unplanned inspections, etc. The data may be collected by interfacing with readily available source of contracting and project management systems. In some implementations, the data can be collected indirectly from any news or announcements about the project.

At 236, the server utilizes the generated process minor ML model to monitor for process deviations. The work at a large construction site usually follows rigorous and well-defined processes and steps throughout the lifecycle of the project execution. The process deviation data may include any traces related to any deviation to the planned and mandated processes throughout the different stages of implementation. The monitoring may involve collecting, storing, and analyzing data on the work progress, safety processes, delivery processes, etc. The data may be collected by interfacing with readily available source of contracting and project management systems. Monitoring for process deviations may be very relevant due to their high impact on safety at the construction site 110.

At 238, the server utilizes the generated recommendation ML model to monitor for safety recommendations. Th work at a large construction site usually follows rigorous and well-defined safety mitigation actions and control measures for any observed risky act or activity, as well as planned risk activities. The monitoring may involve collecting, storing, and analyzing data on any mitigation and controls measures related to known/planned hazardous activities, such as, working at heights. In some implementations, the monitoring may involve analyzing data for any emerging unsafe act at the construction site 110, for example, a worker violating safety rules and regulations at the construction site.

At 240, the server utilizes the generated visual cascaded model to monitor for cascaded world view. The cascaded worldview enables the system to understand the visual scenes that are captured by the one or more cameras 102 at the construction site 110. The understanding of the scenes may involve detecting objects and entities, such as, detecting people, buildings, types of vehicles, etc. The understanding of the scenes may involve detecting scenarios, such as, a walking person or a moving vehicle, and more complex models for detecting safe and violation scenarios.

From 240, method 200 can proceed to FIG. 2B.

FIG. 2B is a continuation of the partial flowchart from FIG. 2A of a process for context-aware risk monitoring based on and PTZ cameras, according to an implementation of the present disclosure.

### System Workflow

At 242, the system observes a panoramic camera scene. This may involve the one or more cameras at a construction site 110, or large work site capturing image data of the construction site and communicating the image data to the server that supports the functionality of the described approach. The one or more cameras 102 at the construction site 110 may be PTZ cameras which are configured to capture panoramic images of the construction site 110. In some implementations, each of the one or more cameras at the construction site 110 are configured to capture image data of a particular area of the construction site 110. For example, camera A may be configured to capture image data of area A and camera B is configured to capture image data of area B. In some implementations, a single camera is configured to capture panoramic images of the entire construction site 110.

The one or more cameras at the construction site 110 may communicate the captured images to the server. The images captured by the one or more cameras at the construction site 110 are communicated to the server in real-time or near real-time speeds. In some implementations, the server receives and processes the image data and the contextual event data associated with the construction site 110. In other implementations, the processing device of the camera 102 may be configured to process the image data and the contextual event data.

At 244, the server processes and analyzes the received image data and the associated contextual event data to understand the general scene at the construction site 110. For example, one or more ML models are used to recognize the scene and provide a general understanding of the scene.

At 246, the server detects safety relevant activities, zone, and scenes at the construction site 110 based on processing the image data and contextual event data. The server utilizes the one or more generated ML models to detect each of the one or more persons, entities, objects, activities, and zones related to safety and safety hazards at the construction site 110. For example, the server utilizes the incidents model to monitor for incident likelihood and utilize the contextual model to monitor for worker activities.

At 248, the server determines whether focused high spatial-resolution images of the construction site are required. The server may determine that focused high spatial-resolution data of the scene is required when the confidence or probability of prediction of whether or not a hazard has occurred is below a threshold value. In some implementations, the server may determine that focused high spatial-resolution image data of the scene is required when the image data received may indicate that a potential hazard occurred in a peripheral area or at the edge of frame of the one or more captured images.

At 250, when the server determines that focused high spatial-resolution images are required to identify whether a safety hazard occurred, the server may command the one or more cameras at the construction site 110 to adjust one or more parameters to capture focused high spatial-resolution images. The server may utilize the at least a portion of the data stored in the models space 202 to determine which camera to adjust and how to adjust the camera to get the necessary focused high spatial-resolution images. The server may command at least one of the one or more cameras to pan, tilt, or to zoom in or out to capture focused high spatial-resolution images. In some implementations, where the construction site 110 includes one or more work zones and each work zone is monitored by a specific camera, the server may command two cameras to capture images of one work zone to increase the image data received.

At 252, when the server determines that focused high spatial-resolution images are not required, the server identifies safety hazards and violations based on the previously captured image data. The server may utilize the one or more ML models and/or at least a portion of the data stored in the models space 202 to analyze and or parse the image data and contextual event data stored at the server to determine whether a hazard has occurred. The server may use stacking and cascading methods to detect whether a hazard occurs. In these implementations, the server may use received data to train multiple diverse ML models and combine the predictions of each of the multiple models to make predictions using a decision tree voting model, a meta-model, or any other suitable model.

At 254, when the server determines that no hazards have been identified, the server communicates a notification to a dashboard at the construction site 110 indicating that no hazard occurred.

At 256, when the server determines that a hazard occurred at the construction site 110, an alert event is fired. The server may communicate a notification to the dashboard indicating that a hazard occurred. In some implementations, the notification may include the details of the hazard detected.

At 258, the server determines the mitigation controls associated with the detected hazard and includes the mitigation suggestions in a notification which is communicated to the user device of a worker at the site. For example, a notification alerting the worker of the hazard and including the steps to mitigate the hazard may be communicated to the electronic device of a manager at the construction site 110.

At 260, the server communicates a notification to the dashboard to display the detected hazard and the mitigation steps to control the hazard. In some implementations, the dashboard may be updated to indicate that the hazard was resolved when the mitigation steps are performed at the construction site 110.

From 260, method 200 can proceed to FIG. 2A.

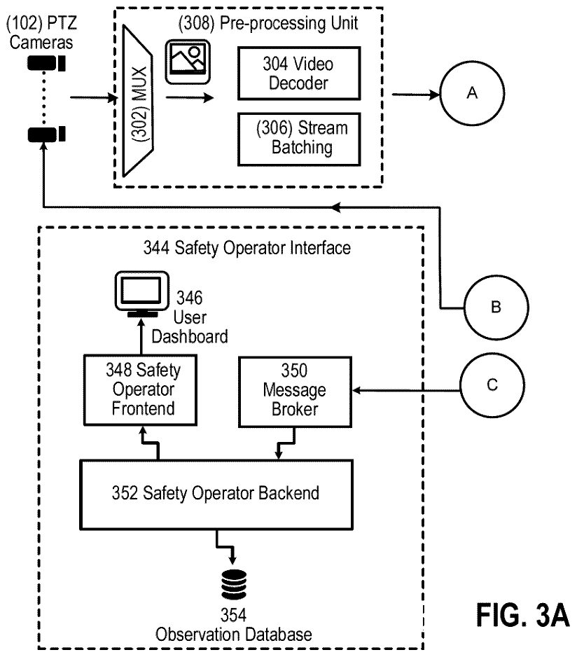

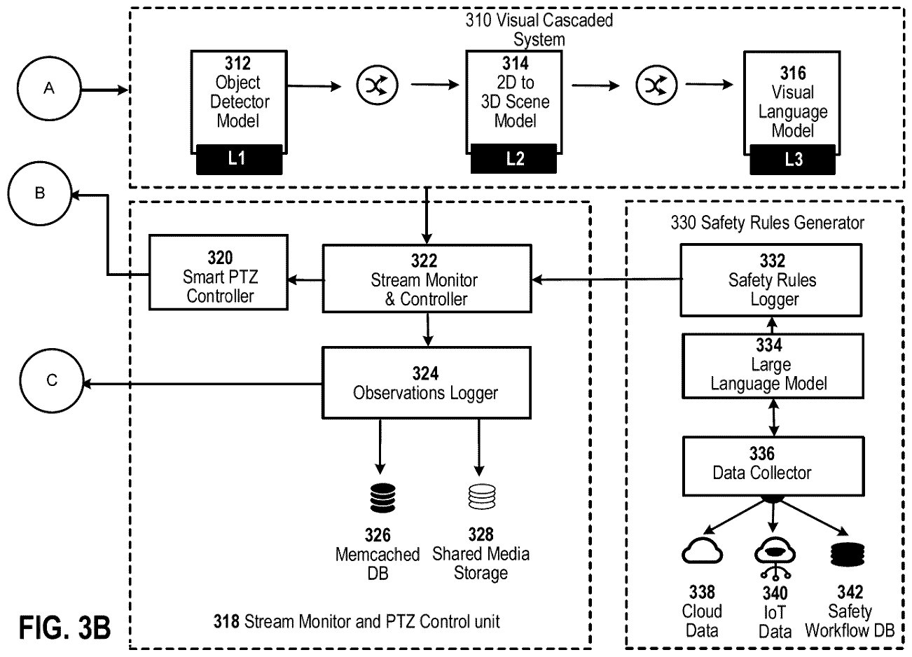

FIG. 3A is a partial block diagram of a system architecture of adaptive context-aware risk video monitoring system, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

As illustrated in FIG. 3A, the system includes one or more PTZ cameras which are strategically placed across a monitored construction site 110. The one or more PTZ cameras are configured to capture real-time image data which captures the various work zones at the construction site 110. The PTZ cameras are configured to pan, that is move horizontally, to tilt, that is to move vertically, and to zoom in or to zoom out. The functionality of the one or more PTZ cameras allows for dynamic adjustment of the camera parameters which allows for optimal monitoring of the construction site 110.

The input from the one or more PTZ cameras located at the construction site 110 is communicated to a preprocessing unit 308 at the server. In some implementations, the preprocessing unit 308 is a separate server that is in communication with the server that supports the functionality of the system. In other implementations, the preprocessing unit 308 is a specialized segment of the server. The preprocessing unit 308 includes a multiplexer (MUX) module 302, a video decoder 304, and a stream batching module 306.

The multiplexer (MUX) module 302 of the processing unit 308 receives the input from the one or more cameras and combines the multiple video streams into a single output. The MUX is configured to efficiently manage the data flow of the video streams data from the one or more cameras. The video decoder 304 converts the compressed video signals into raw video data streams which can be further processed and analyzed during preprocessing. For example, the video decoder converts the H.264 video signals into raw video data streams. The raw video data streams are bundled before being processed by the stream batching module 306. The stream batching module 306 is configured to streamline the processing of the video data streams. The stream batching module 306 enhances the efficiency of the data processing by processing multiple streams simultaneously.

From 308, method 300 can proceed to FIG. 3B.

FIG. 3B is a continuation of the partial block diagram from FIG. 3A of a system architecture of adaptive context-aware risk video monitoring system, according to an implementation of the present disclosure.

As illustrated in FIG. 3B, the preprocessing unit 308 is in communication with the visual cascaded system 310. In some implementations, the visual cascade system 310 is a specialized segment of the server that supports the functionality of the system. The visual cascaded system 310 consists of three artificial intelligence (AI) processing layers, an object detector model 312, a two-dimensional (2D) to three-dimensional (3D) scene model 314, and a visual language model 316. The first layer of the AI processing layers is the object detector model 312. The object detector model 312 is configured to detect critical objects and events within the raw video data streams. For example, the object detector model 312 is configured to detect people and personal protection equipment (PPE) compliance. The detector model 312 can be trained to identify any suitable object or event. For example, the object detector model 312 can be trained to identify hazards, poor housekeeping, unsafe practices, or any other suitable event.

The second layer of the AI processing layers is the 2D to 3D scene model 314. The 2D to 3D scene model 314 is configured to perform advanced data analysis on the raw video streams. The 2D to 3D scene model 314 can perform instance segmentation to identify individual objects within scenes of the raw video data streams, and depth estimation to calculate distances from the camera 102. The 2D to 3D scene model 314 can also perform 3D object detection to recognize objects in three dimensions, and 2D to 3D scene reconstruction to convert 2D images into 3D representations. The 2D to 3D scene model 314 can provide precise measurements, such as, worker height, crane height, or equipment distance. The 2D to 3D scene model 314 can support the detection of complex use cases. For example, the 2D to 3D scene model 314 can be trained to detect when a worker is near an edge or to detect holes.

The third layer of the AI processing layers is the visual language model 316. The visual language model 316. The visual language model 316 combines the received input from the object detector model 312, 2D to 3D scene model 314, and actual scene data. The 2D to 3D scene model 314 is trained to detect complex hazards, such as, a lifted loads that may fall above a worker. The visual language model 316 is configured to proactively detect potential hazards mitigations, such as, adding a barricade around dangerous areas such as excavation and lifting area. The visual language model 316 plays a pivotal role in enhancing safety and proactive hazard detection at the construction site 110.

The stream monitor and PTZ control unit 318 is in communication with the visual cascaded system 310. The stream monitor and PTZ control unit 318 includes a smart PTZ controller 320, a stream monitor and controller 322, and an observations logger module 324. The stream monitor and controller 322 oversees the entire streaming process and ensures data integrity, synchronization and real-time updates. The stream monitor and controller 322 is configured to monitor video quality of the video data received from the one or more cameras, frame rates and event triggers. The smart PTZ controller 320 is configured to automatically control the one or more PTZ cameras at the construction site 110. The smart PTZ controller 320 controls the rotating, tilting, panning, and or zooming into or out of different areas or work zones at the construction site 110. The smart PTZ controller 320 controls the one or more cameras to focus on a detected hazard. For example, the smart PTZ controller 320 controls the camera to zoom in on an area where a hazard is detected.

From 320, method 300 can proceed to FIG. 3A.

The observations logger module 324 is configured to record specific observations during video monitoring, and to capture any safety violations, incidents, and anomalies. The observations logger module 324 records the data to one or more different databases. In some implementations, the observations logger module 324 records the data to a cached database 326. In other implementations, the observations logger module 324 records the data to a shared media storage 328.

From 324, method 300 can proceed to FIG. 3A.

The safety rules generator unit 330 is in communication with the stream monitor and PTZ control unit 318. The safety rules generator unit 330 includes a safety rules logger 332, a LLM 334, and a data collector 336. The safety rules generator unit 330 is configured to generate and log safety rules to be monitored for and enforced. The data collector 336 is configured to collect and acquire data from multiple different data sources. As illustrated in FIG. 3B, the data collector 336 can receive data from a safety workflow database 342, from one or more IoT sensors 340, and safety data available from a safety community 338 availed on the cloud 338.

The LLM 334 creates detailed safety rules for specific work zones, equipment, and work types. These safety rules are created based on the historical data, environmental conditions, and incident history of the construction site 110. The safety rules logger 332 is configured to store the generated safety rules and provides the safety rules to the stream monitor and controller 322. The stream monitor and controller 322 is configured to use the safety rules for real time safety enforcement.

As illustrated in FIG. 3A, the safety operator interface 344 is in communication with the observations logger module 324. The safety operator interface 344 consists of three modules that collectively expose the monitored safety observations in various ways to the safety operator and allow the safety operator to customize the tracking as required. The message broker 350 acts as a communication hub that routes observation events, alerts, and notifications to the right component. The safety operator backend 352 is the gateway to interface the frontend modules with the backend infrastructure and its services. The safety operator backend 352 ensures observations data persistence and retrieval in the observations database 354. The safety operator frontend 348 is responsible for a user-friendly interface for safety operators, which displays real-time video feeds, alerts, and safety metrics. The safety operator frontend 348 allows rule adjustments, incident tracking, and historical analysis. This interface is accessible through a dashboard 346 on the user's interaction device.

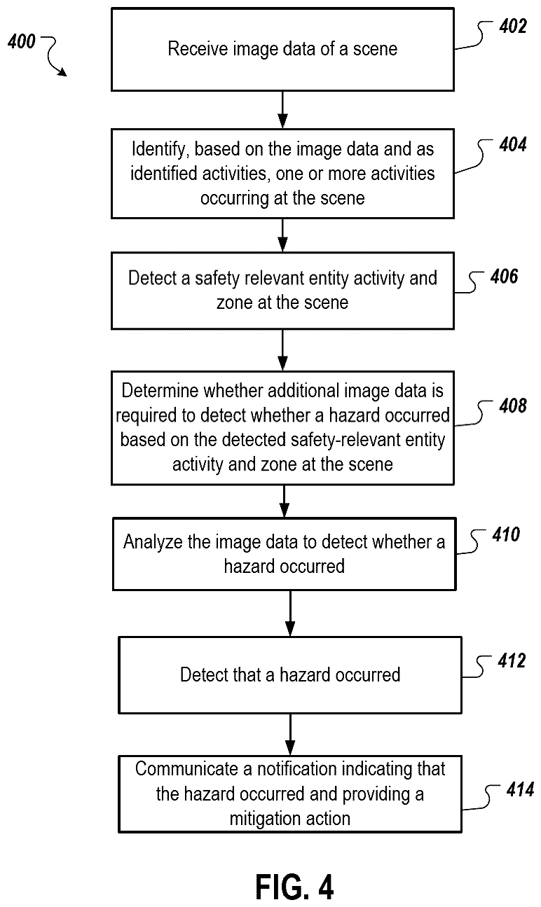

FIG. 4 is a flow chart illustrating a process 400 for communicating a notification indicating that a hazard occurred and providing a mitigation action. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

The following describes process 400 as being performed by components of the systems 200 and 300 described above with respect to FIGS. 2A, 2B, 3A, and 3B. However, the process 400 may be performed by other systems and configurations. Briefly, the process 400 may include receiving image data of a scene (402), identifying one or more activities occurring at the scene (404), detecting a safety relevant entity activity and zone at the scene (406), determine whether additional image data is required to detect whether a hazard occurred based on the detected safety-relevant entity activity and zone at the scene (408), analyze the image data to detect whether a hazard occurred (410), detect that a hazard occurred (412), and communicate a notification indicating that the hazard occurred and providing a mitigation action (414).

In more detail, process 400 may include receiving image data of a scene (402). For example, this may correspond to a server that collects, analyzes, and stores historical incident data and hazard data receiving, from one or more cameras, image data of a scene. The one or more cameras 102 may be PTZ cameras which are configured to continuously capture images of a construction site (e.g., 100a or 100b in FIG. 1A or 1B, respectively) to proactively identify potential hazards at the site 110. In some implementations, the one or more cameras 102 may capture panoramic images of one or more different areas/work zones 104, 106, and 108 of the construction site 110. For example, as illustrated in FIGS. 1A and 1B, a single camera 102 may capture panoramic images of each of the one or more different areas/work zones 104, 106, and 108 at the construction site 110. In some implementations, one or more cameras 102 may be located throughout the construction site 110, and each of the one or more cameras 102 may capture images of the different areas/work zones 104, 106, and 108 at the construction site 110. For example, a first camera may capture images of the first work zone 104, a second camera 106 may capture images of the second work zone 108, and a third camera may capture images of the third work zone 108.

In some implementations, the one or more cameras 102 may be configured to constantly communicate the captured image data to the server. For example, the one or more cameras 102 may communicate the captured image data to the server in real-time. In other implementations, the one or more camera 102 may be configured to periodically communicate the captured image data to the server. For example, the one or more cameras 102 may communicate the captured image data to the server every 10 seconds, or any other appropriate time interval. In yet another implementation, the one or more cameras 102 may be configured to store and analyze the captured image data.

The process 400 may include identifying, based on the image data and as identified activities, one or more activities occurring at the scene (404). For example, this may include the server utilizing one or more ML models to identify the one or more activities at the construction site 110. The one or more processing devices at the server may receive data from a plurality of different data sources, and may generate and train one or more ML models based on the received data. In more detail, the one or more processing devices at server may receive historical incident data related to minor safety incidents, major safety incidents, safety observations, and any other suitable incident data from a plurality of monitored construction sites, large industrial work sites, or any other suitable work zone area. The processing devices at the server may utilize the received historical incident data to train a ML model which is configured to identify safety incidents. The ML model may be configured to identify safety incidents, and the ML model may be continuously updated by the server based on the server periodically receiving new incident data from the plurality of monitored construction sites and large industrial work sites. The server may also continuously receive worker activity data. The worker activity data may be based on Internet of Things (IoT) contextual event data and events which are generated by multiple IoT sensors located at a plurality of construction sites. The IoT contextual event data received by the server may be live or near-live contextual event data. The server may store the contextual event data and may aggregate the contextual event data into a contextual model which produces a digital twin of a construction site including people, objects and the physical spaces within the construction site. The server may also receive contract event data from one or more other computing systems which store documents related to construction sites, such as, for example, contracts, work orders, and any other suitable documents. The server may generate a fine-tuned LLM based on the received contract event data. The LLM may be trained on large datasets of documents received and stored at the server.

The server may utilize a minor model to monitor for process deviation. The model may be configured to analyze data stored at the server to identify executional paths and processes within the data associated with a particular project workflow. The server may also receive and store, historical and general instruction data related to incident mitigation and control measures. The historical and general instruction data may be used to generate and train a ML model that is configured to identify an appropriate mitigation for a detected incident. The ML model may be periodically updated by the server when the server receives additional data related to incident mitigation and control measures. The server may receive visual data representing the physical world captured by one or more cameras, and may generate and train a visual model to detect basic and core entities and actions in an image of a construction site based on the visual model.

The server may then utilize the one or more generated ML models along with one or more image processing techniques to identify activities occurring at the scene based on the received image data of the scene. The one or more processing devices at the server may segment the received images into one or more different parts, for example, the server may identify persons, areas of interest, or objects within the captured images. In some implementations, the segmentation process may involve thresholding techniques, edge detection techniques, clustering techniques, or any other suitable segmentation technique which can be used to identify persons, areas or interest, or objects within the captured images. When the server identifies persons, areas of interest, or objects, the one or more ML models are used to confirm and classify the extracted features. For example, as illustrated in FIG. 1A, the server may identify work zone 104 as an area of interest and can further identify a person near to a tractor in the image.

The process 400 may include detecting a safety relevant entity activity and zone at the scene (406). The one or more processing devices at the server may detect and identify each of the one or more entities, persons, objects, activities, and or work zones at the construction site 110 which are related to safety and or safety hazards. For example, this may involve the one or more processing devices at the server utilizing feature extraction and classification techniques to identify one or more safety relevant entity activities and work zones within the one or more captured images. As illustrated in FIG. 1A, the server can identify work zone 104 and can identify a person near to a tractor in work zone 104. The server may determine that the work zone 104 is a safe zone based on the server parsing and processing all the relevant data associated with the work zone 104. For example, the server may determine that the person near the tractor is a threshold safety distance from the tractor, and based on the person 110 being a threshold safety distance from the tractor, and no other activities being carried out in the work zone 104, the work zone 104 is determined to be safe.

The server can identify work zone 106 as including a safety relevant entity activity and zone. As illustrated in FIG. 1A, the server can identify work zone 106, where two cranes are in close proximity to each other as a safety relevant entity activity and zone. The work zone 106 can be determined to be potentially hazardous based on the two cranes being less than a threshold distance apart from each other. Based on additional data associated with the work zone 106, for example, project data which indicates parallel operation time for the two cranes based on the project schedule, the server can determine that the work zone is not hazardous based on the project data confirming the use of the two cranes simultaneously.

The server can identify work zone 108 as including a safety relevant entity activity and zone. As illustrated in FG. 1A, the server can identify work zone 108 which includes an unexpected worker working at a height that is more than a threshold height above the ground. The work zone 108 can be determined to be potentially hazardous based project data not indicating that the worker should currently be working at this height.

The process 400 may include determining whether additional image data is required to detect whether a hazard occurred based on the detected safety-relevant entity activity and zone at the scene (408). In some implementations, the server may determine that additional image data is required when focused high spatial-resolution image data of a work zone is required. For example, when the work zone is tagged as being potentially hazardous and when no other data received at the server can confirm the work occurring in the work zone. For example, the server may determine that focused high spatial-resolution image data of a work zone is required when a worker is working at a height outside of the threshold height above ground, as illustrated in FIG. 1A. In some implementations, the server may determine that focused high spatial-resolution image data of a work zone is required when the server cannot determine with a high enough confidence that the work zone is hazardous. The server may determine that additional image data is required when the server determines that image data with a better field of view of the work zone is required.

The process 400 may include analyzing the image data to detect whether a hazard occurred if additional image data is not required (410). For example, this may involve the server determining that additional image data is not required to determine whether a hazard has occurred. In this implementation, the server may utilize the one or more ML models to analyze and or parse the image data and other data stored at the server to determine whether a hazard has occurred. For example, the server may use the ML model trained with historical incident data to determine whether a hazard occurred. In some implementations, the server may use the ML model trained with historical incident data to determine whether a minor hazard or a major hazard occurred. In some implementations, the server may use stacking methods to detect whether a hazard occurs. In these implementations the server may use received data to train multiple diverse ML models and combine the predictions of each of the multiple models to make predictions using a decision tree voting model, a meta-model, or any other suitable model. For example, the server may use the ML model trained with historical incident data, the ML model trained with worker activity data, and the fine-tuned LLM trained on contract event data to predict whether a hazard occurred.

The process 400 may include detecting that a hazard occurred (412). This involves the server determining, based on the predictions of the one or more ML modules that a hazard occurred at the construction site 110. The process 400 may include communicating a notification indicating that the hazard occurred and providing a mitigation action (414). This can involve the server communicating a notification to a user device of a user associated with the construction site 110. For example, the server may communicate a push notification to the electronic device of a manager of the construction site 110 indicating that a hazard occurred and the steps necessary to mitigate the hazard. For the example illustrated in FIGS. 1A and 1B, the server may communicate a notification indicating that the worker on the oil rig immediately return to the ground level. In some implementations, the notification may be communicated to a large electronic screen that is located at the construction site 110, and that may be visible to the various workers at the construction site 110. In some implementations, when the detected hazard is classified as a major hazard, the notification may be an alarm. For example, the server may communicate with one or more speakers located through the construction site 110 to sound an audible alarm. In another example, the server may communicate with one or more LED lights located throughout the construction site 110 to output a visible alarm.

In some implementations, the server may determine that additional image data of the scene is required. The server may determine that additional image data of the scene is required when the server determines that high resolution image data or image data with a better field of view is required. The server may determine that focused high spatial-resolution data of the scene is required when the confidence or probability of prediction of whether or not a hazard has occurred is below a threshold value. For example, the server may determine that a hazard occurred with a 50% confidence, and based on the confidence value being below a threshold value of 80%, the server may determine that focused high spatial-resolution image data of the scene is required. In some implementations, the server may determine that focused high spatial-resolution data of the scene is required when the image data received may indicate that a potential hazard occurred in a peripheral area or at the edge of frame of the one or more captured images. In these implementations, the server may command the one or more cameras at the scene to adjust one or more parameters before capture the focused high spatial-resolution images. For example, the server may command at least one camera at the scene to pan and or tilt the camera before capturing the focused high spatial-resolution images. In some examples, the server may command at least one camera to zoom in before capturing the focused high spatial-resolution images.

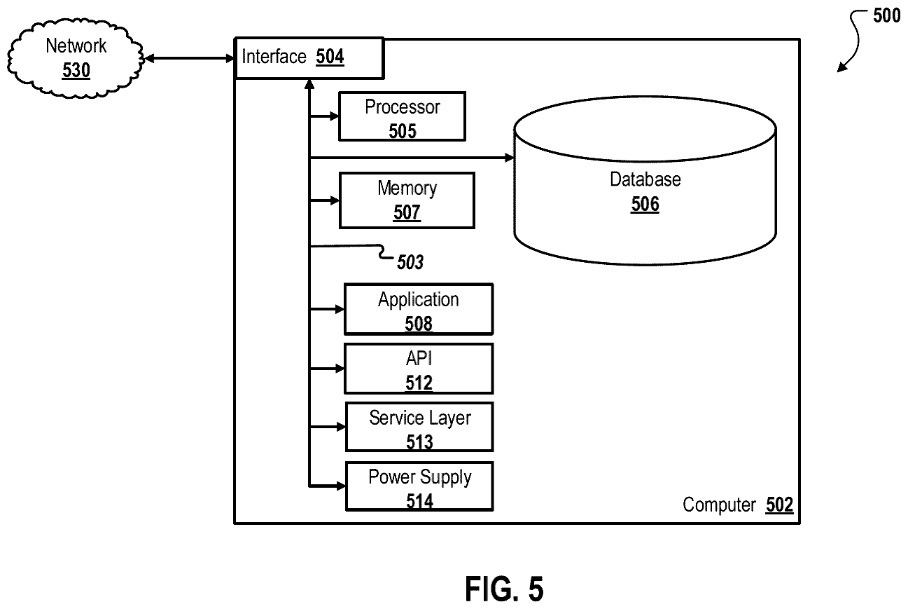

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, computer-implemented system 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

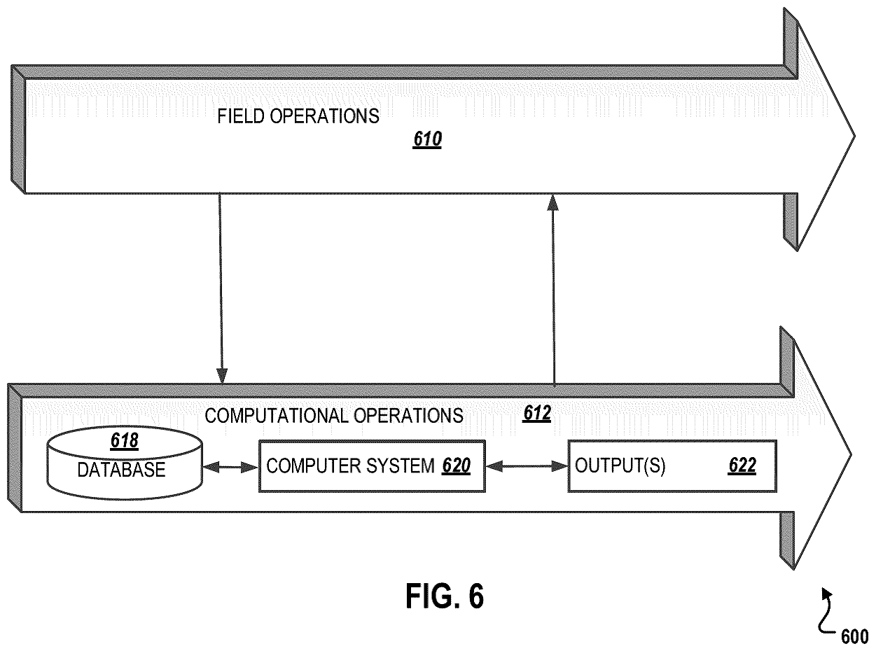

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure can be performed before, during, or in combination with the hydrocarbon production operations 600, specifically, for example, either as field operations 610 or computational operations 612, or both.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively, or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and ML. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Described implementations of the subject matter can include one or more features, alone or in combination.

For example, in a first implementation, a computer-implemented method for potential hazard identification, comprising: receiving, from one or more cameras, image data of a scene; identifying, based on the image data and as identified activities, one or more activities occurring at the scene; based on the identified activities, detecting a safety-relevant entity activity and zone at the scene; determining whether focused high spatial-resolution image data is required to detect whether a hazard occurred based on the detected safety-relevant entity activity and zone at the scene; if focused high spatial-resolution image data is not required, then: analyzing the image data to detect whether a hazard occurred; detecting that a hazard occurred; and communicating to a user device, a notification indicating that the hazard occurred and providing a mitigation action.

The foregoing and other described implementations can each, optionally, include one or more of the following features:
A first feature, combinable with any of the following features, further comprising: determining that focused high spatial-resolution image data is required; adapting at least one parameter of a camera to capture the focused high spatial-resolution image data of the safety-relevant entity activity and zone at the scene; receiving, by the camera, focused high spatial-resolution image data of the safety-relevant entity activity and zone at the scene; analyzing the image data and the focused high spatial-resolution image data to detect whether a hazard occurred; detecting that a hazard has not occurred; and providing a notification indicating that a hazard has not occurred.
A second feature, combinable with any of the previous or following features, wherein receiving from one or more cameras, image data of a scene comprises receiving one or more panoramic images of the scene.
A third feature, combinable with any of the previous or following features, wherein identifying one or more activities occurring at the scene comprises utilizing one or more machine learning modules trained to identify activities.
A fourth feature, combinable with any of the previous or following features, wherein adapting at least one parameter of a camera to capture the focused high spatial-resolution image data of the safety-relevant entity activity and zone at the scene comprises providing instructions to pan the camera, tilt the camera, zoom in, or zoom out.
A fifth feature, combinable with any of the previous or following features, wherein analyzing the image data and the focused high spatial-resolution image data to detect whether a hazard occurred comprises utilizing one or more machine learning modules trained to detect a hazard.
A sixth feature, combinable with any of the previous or following features, further comprising: receiving, at a first time, historical incident and hazard data from one or more different data sources; analyzing the historical incident and hazard data; generating, based on analyzing the historical incident and hazard data, a machine learning module that is trained to identify incidents and hazards; receiving, at a second time after the first time, additional historical incident and hazard data; and updating the machine learning module based on the additional historical incident and hazard data.
A seventh feature, combinable with any of the previous or following features, further comprising: receiving, at a first time, contextual event data from one or more sources; analyzing the contextual event data; generating, based on analyzing the contextual event data a machine learning module that is trained to identify one or more patterns within the contextual event data; utilizing the machine learning module that is trained to identity one or more patterns within the contextual event data to generate a contextual model that represents a digital twin of the scene.
An eighth feature, combinable with any of the previous or following features, further comprising: utilizing the contextual model that represents a digital twin of the scene and the machine learning module that is trained to identify one or more patterns within the contextual event data to identify one or more activities occurring at the scene; based on identifying one or more activities occurring at the scene, determining whether focused high spatial-resolution image data is required to detect whether a hazard occurred at the scene; based on determining that focused high spatial-resolution data is required, adapting at least one parameter of a camera to capture focused high spatial-resolution image data of the scene.

In a second implementation, a non-transitory, computer-readable medium storing one or more instructions executable by a computer system to perform one or more operations comprising: receiving, from one or more cameras, image data of a scene; identifying, based on the image data and as identified activities, one or more activities occurring at the scene; based on the identified activities, detecting a safety-relevant entity activity and zone at the scene; determining whether focused high spatial-resolution image data is required to detect whether a hazard occurred based on the detected safety-relevant entity activity and zone at the scene; if focused high spatial-resolution image data is not required, then: analyzing the image data to detect whether a hazard occurred; detecting that a hazard occurred; and communicating to a user device, a notification indicating that the hazard occurred and providing a mitigation action.

The foregoing and other described implementations can each, optionally, include one or more of the following features:
A first feature, combinable with any of the following features, further comprising: determining that focused high spatial-resolution image data is required; adapting at least one parameter of a camera to capture the focused high spatial-resolution image data of the safety-relevant entity activity and zone at the scene; receiving, by the camera, focused high spatial-resolution image data of the safety-relevant entity activity and zone at the scene; analyzing the image data and the focused high spatial-resolution image data to detect whether a hazard occurred; detecting that a hazard has not occurred; and providing a notification indicating that a hazard has not occurred.
A second feature, combinable with any of the previous or following features, wherein receiving from one or more cameras, image data of a scene comprises receiving one or more panoramic images of the scene.
A third feature, combinable with any of the previous or following features, wherein identifying one or more activities occurring at the scene comprises utilizing one or more machine learning modules trained to identify activities.
A fourth feature, combinable with any of the previous or following features, wherein adapting at least one parameter of a camera to capture the focused high spatial-resolution image data of the safety-relevant entity activity and zone at the scene comprises providing instructions to pan the camera, tilt the camera, zoom in, or zoom out.
A fifth feature, combinable with any of the previous or following features, wherein analyzing the image data and the focused high spatial-resolution image data to detect whether a hazard occurred comprises utilizing one or more machine learning modules trained to detect a hazard.
A sixth feature, combinable with any of the previous or following features, further comprising: receiving, at a first time, historical incident and hazard data from one or more different data sources; analyzing the historical incident and hazard data; generating, based on analyzing the historical incident and hazard data, a machine learning module that is trained to identify incidents and hazards; receiving, at a second time after the first time, additional historical incident and hazard data; and updating the machine learning module based on the additional historical incident and hazard data.
A seventh feature, combinable with any of the previous or following features, further comprising: receiving, at a first time, contextual event data from one or more sources; analyzing the contextual event data; generating, based on analyzing the contextual event data a machine learning module that is trained to identify one or more patterns within the contextual event data; utilizing the machine learning module that is trained to identity one or more patterns within the contextual event data to generate a contextual model that represents a digital twin of the scene.
An eighth feature, combinable with any of the previous or following features, further comprising: utilizing the contextual model that represents a digital twin of the scene and the machine learning module that is trained to identify one or more patterns within the contextual event data to identify one or more activities occurring at the scene; based on identifying one or more activities occurring at the scene, determining whether focused high spatial-resolution image data is required to detect whether a hazard occurred at the scene; based on determining that focused high spatial-resolution data is required, adapting at least one parameter of a camera to capture focused high spatial-resolution image data of the scene.

In a third implementations, a computer-implemented system comprising: one or more computers; and one or more computer memory devices interoperably coupled with the one or more computers and having tangible, non-transitory, machine-readable media storing one or more instructions that, when executed by the one or more computers, perform one or more operations, comprising: receiving, from one or more cameras, image data of a scene; identifying, based on the image data and as identified activities, one or more activities occurring at the scene; based on the identified activities, detecting a safety-relevant entity activity and zone at the scene; determining whether focused high spatial-resolution image data is required to detect whether a hazard occurred based on the detected safety-relevant entity activity and zone at the scene; if focused high spatial-resolution image data is not required, then: analyzing the image data to detect whether a hazard occurred; detecting that a hazard occurred; and communicating to a user device, a notification indicating that the hazard occurred and providing a mitigation action.

The foregoing and other described implementations can each, optionally, include one or more of the following features:
A first feature, combinable with any of the following features, combinable with any of the following features, further comprising: determining that focused high spatial-resolution image data is required; adapting at least one parameter of a camera to capture the focused high spatial-resolution image data of the safety-relevant entity activity and zone at the scene; receiving, by the camera, focused high spatial-resolution image data of the safety-relevant entity activity and zone at the scene; analyzing the image data and the focused high spatial-resolution image data to detect whether a hazard occurred; detecting that a hazard has not occurred; and providing a notification indicating that a hazard has not occurred.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for potential hazard identification, comprising:
receiving, from one or more cameras, image data of a scene;
identifying, based on the image data and as identified activities, one or more activities occurring at the scene;
based on the identified activities, detecting a safety-relevant entity activity and zone at the scene;
determining whether additional image data is required to detect whether a hazard occurred based on the detected safety-relevant entity activity and zone at the scene;
if additional image data is not required, then:
analyzing the image data to detect whether a hazard occurred;
detecting that a hazard occurred; and
communicating to a user device, a notification indicating that the hazard occurred and providing a mitigation action, wherein the additional image data is focused high spatial-resolution image data.

2. The computer-implemented method of claim 1, further comprising:
determining that additional image data is required;
adapting at least one parameter of a camera to capture the additional image data by capturing focused high spatial-resolution image data of the safety-relevant entity activity and zone at the scene;
receiving, by the camera, the focused high spatial-resolution image data of the safety-relevant entity activity and zone at the scene;
analyzing the image data and the additional image data to detect whether a hazard occurred;
detecting that a hazard has not occurred; and
providing a notification indicating that a hazard has not occurred.

3. The computer-implemented method of claim 1, wherein receiving from one or more cameras, image data of a scene comprises receiving one or more panoramic images of the scene.

4. The computer-implemented method of claim 1, wherein identifying one or more activities occurring at the scene comprises utilizing one or more machine learning modules trained to identify activities.

5. The computer-implemented method of claim 2, wherein adapting at least one parameter of a camera to capture the focused high spatial-resolution image data of the safety-relevant entity activity and zone at the scene comprises providing instructions to pan the camera, tilt the camera, zoom in, or zoom out.

6. The computer-implemented method of claim 2, wherein analyzing the image data and the focused high spatial-resolution image data to detect whether a hazard occurred comprises utilizing one or more machine learning modules trained to detect a hazard.

7. The computer-implemented method of claim 1, further comprising:
receiving, at a first time, historical incident and hazard data from one or more different data sources;
analyzing the historical incident and hazard data;
generating, based on analyzing the historical incident and hazard data, a machine learning module that is trained to identify incidents and hazards;
receiving, at a second time after the first time, additional historical incident and hazard data; and
updating the machine learning module based on the additional historical incident and hazard data.

8. The computer-implemented method of claim 1, further comprising:
receiving, at a first time, contextual event data from one or more sources;
analyzing the contextual event data;
generating, based on analyzing the contextual event data a machine learning module that is trained to identify one or more patterns within the contextual event data; and
utilizing the machine learning module that is trained to identity one or more patterns within the contextual event data to generate a contextual model that represents a digital twin of the scene.

9. The computer-implemented method of claim 8, further comprising: utilizing the contextual model that represents a digital twin of the scene and the machine learning module that is trained to identify one or more patterns within the contextual event data to identify one or more activities occurring at the scene;
based on identifying one or more activities occurring at the scene, determining whether additional image data is required to detect whether a hazard occurred at the scene; and
based on determining that additional image data is required, adapting at least one parameter of a camera to capture focused high spatial-resolution image data of the scene.

10. A non-transitory, computer-readable medium storing one or more instructions executable by a computer system to perform one or more operations, comprising:
receiving, from one or more cameras, image data of a scene;
identifying, based on the image data and as identified activities, one or more activities occurring at the scene;
based on the identified activities, detecting a safety-relevant entity activity and zone at the scene;
determining whether additional image data is required to detect whether a hazard occurred based on the detected safety-relevant entity activity and zone at the scene;
if additional image data is not required, then:
analyzing the image data to detect whether a hazard occurred;
detecting that a hazard occurred; and
communicating to a user device, a notification indicating that the hazard occurred and providing a mitigation action, wherein the additional image data is focused high spatial-resolution image data.

11. The non-transitory, computer-readable medium of claim 10, comprising:
determining that additional image data is required;
adapting at least one parameter of a camera to capture the additional image data by capturing focused high spatial-resolution image data of the safety-relevant entity activity and zone at the scene;
receiving, by the camera, the focused high spatial-resolution image data of the safety-relevant entity activity and zone at the scene;
analyzing the image data and the additional image data to detect whether a hazard occurred;
detecting that a hazard has not occurred; and
providing a notification indicating that a hazard has not occurred.

12. The non-transitory, computer-readable medium of claim 10, wherein receiving from one or more cameras, image data of a scene comprises receiving one or more panoramic images of the scene.

13. The non-transitory, computer-readable medium of claim 10, wherein identifying one or more activities occurring at the scene comprises utilizing one or more machine learning modules trained to identify activities.

14. The non-transitory, computer-readable medium of claim 12, wherein adapting at least one parameter of a camera to capture the focused high spatial-resolution image data of the safety-relevant entity activity and zone at the scene comprises providing instructions to pan the camera, tilt the camera, zoom in, or zoom out.

15. The non-transitory, computer-readable medium of claim 12, wherein analyzing the image data and the focused high spatial-resolution image data to detect whether a hazard occurred comprises utilizing one or more machine learning modules trained to detect a hazard.

16. The non-transitory, computer-readable medium of claim 10, comprising:
receiving, at a first time, historical incident and hazard data from one or more different data sources;
analyzing the historical incident and hazard data;
generating, based on analyzing the historical incident and hazard data, a machine learning module that is trained to identify incidents and hazards;
receiving, at a second time after the first time, additional historical incident and hazard data; and
updating the machine learning module based on the additional historical incident and hazard data.

17. The non-transitory, computer-readable medium of claim 10, comprising:
receiving, at a first time, contextual event data from one or more sources;
analyzing the contextual event data;
generating, based on analyzing the contextual event data a machine learning module that is trained to identify one or more patterns within the contextual event data; and
utilizing the machine learning module that is trained to identity one or more patterns within the contextual event data to generate a contextual model that represents a digital twin of the scene.

18. The non-transitory, computer-readable medium of claim 17, comprising: utilizing the contextual model that represents a digital twin of the scene and the machine learning module that is trained to identify one or more patterns within the contextual event data to identify one or more activities occurring at the scene;
based on identifying one or more activities occurring at the scene, determining whether additional image data is required to detect whether a hazard occurred at the scene; and
based on determining that additional image data is required, adapting at least one parameter of a camera to capture focused high spatial-resolution image data of the scene.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving, from one or more cameras, image data of a scene;
identifying, based on the image data and as identified activities, one or more activities occurring at the scene;
based on the identified activities, detecting a safety-relevant entity activity and zone at the scene;
determining whether additional image data is required to detect whether a hazard occurred based on the detected safety-relevant entity activity and zone at the scene;
if additional image data is not required, then:
analyzing the image data to detect whether a hazard occurred;
detecting that a hazard occurred; and
communicating to a user device, a notification indicating that the hazard occurred and providing a mitigation action, wherein the additional image data is focused high spatial-resolution image data.

20. The computer-implemented system of claim 19, further comprising:
determining that additional image data is required;
adapting at least one parameter of a camera to capture the additional image data by capturing focused high spatial-resolution image data of the safety-relevant entity activity and zone at the scene;
receiving, by the camera, the focused high spatial-resolution image data of the safety-relevant entity activity and zone at the scene;
analyzing the image data and the focused high spatial-resolution image data to detect whether a hazard occurred;
detecting that a hazard has not occurred; and
providing a notification indicating that a hazard has not occurred.
